(19) United States
(12) Patent Application Publication
(10) Pub. No.: US 2025/0323333 A1
(43) Pub. Date: Oct. 16, 2025

(54) PACKAGING MATERIAL FOR BATTERY AND SECONDARY BATTERY COMPRISING SAME

(71) Applicant: SK ON CO., LTD., Seoul (KR)

(72) Inventors: Yoon Ji JO, Daejeon (KR); Chang Mook HWANG, Daejeon (KR); Hyun Ji KIM, Daejeon (KR); Jong Hyeok LEE, Daejeon (KR)

(21) Appl. No.: 19/196,187

(22) Filed: May 1, 2025

Related U.S. Application Data
(63) Continuation of application No. PCT/KR2023/015398, filed on Oct. 6, 2023.

(30) Foreign Application Priority Data
Nov. 2, 2022 (KR) 10-2022-0144799

(51) Int. Cl. H01M 10/48; H01M 10/052; H01M 10/0585; H01M 50/105; H01M 50/119; H01M 50/124; H01M 50/126; H01M 50/178

(52) U.S. Cl. CPC H01M 10/488; H01M 10/052; H01M 10/0585; H01M 50/105; H01M 50/119; H01M 50/1245; H01M 50/126; H01M 50/178

(57) ABSTRACT

A packaging material for a battery according to embodiments of the present disclosure includes a metal layer, an inner sealant layer, an outer substrate layer, and a thermochromic pigment-containing adhesive layer formed between the metal layer and the outer substrate layer. Through a pouch including the packaging material for a battery, it is possible to implement a secondary battery capable of monitoring internal heat generation from the outside.

This application is a bypass continuation application of PCT/KR2023/015398 filed on Oct. 6, 2023, which claims priority to Korean Patent Application No. 10-2022-0144799 filed on Nov. 2, 2022. The disclosure of each of the foregoing applications is incorporated herein by reference in its entirety.

### TECHNICAL FIELD

The present disclosure relates to a packaging material for a battery and a secondary battery including the same. More specifically, the present disclosure relates to a packaging material for a battery having a multi-layer structure, and a secondary battery formed of the packaging material including an adhesive layer.

### BACKGROUND ART

A secondary battery is a battery that can be repeatedly charged and discharged. With rapid progress of information and communication technology and display industries, the secondary battery has been widely applied to various portable electronic telecommunication devices such as a camcorder, a mobile phone, a laptop computer, etc. as their power sources. Recently, a battery pack including the secondary battery has also been developed and applied to eco-friendly automobiles as their power sources.

In the secondary batteries used as power sources in various systems, rapid charging performance is required, and problems occur due to heat generated in the secondary battery during the rapid charging process. Due to the heat generated when the secondary battery is rapidly charged, the cathode material structure collapses, which leads to a decrease in the battery performance, or a lithium-plating phenomenon, in which lithium is deposited on the surface of the anode, may occur, thereby resulting in a deterioration in the performance of the secondary battery.

In addition, the lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are accommodated. When a problem such as an internal short circuit occurs due to damage to the separation membrane inside the secondary battery, an abnormal increase in temperature may occur, which may lead to a fire.

In order to prevent these problems, methods such as attaching a temperature sensor as a means to monitor temperature changes during the operation of the secondary battery have been proposed. However, there are disadvantages such as difficulty in accurately measuring the temperature inside a sealed cell, the possibility of sensor malfunction, and limitations in reducing the weight and size of the battery due to the volume and mass of the sensor.

### SUMMARY OF INVENTION

### Problems to be Solved by Invention

An object of the present disclosure is to provide a packaging material for a battery.

Another object of the present disclosure is to provide a secondary battery including the packaging material for a battery.

### Means for Solving Problems

A packaging material for a battery according to exemplary embodiments includes: a metal layer; an inner sealant layer formed on a lower surface of the metal layer; an outer substrate layer laminated on an upper surface of the metal layer; and a thermochromic pigment-containing adhesive layer formed between the metal layer and the outer substrate layer.

According to exemplary embodiments, the thermochromic pigment-containing adhesive layer may include a first region and a second region having different contents of the thermochromic pigments per unit area, and the content of the thermochromic pigment per unit area in the first region is greater than that in the second region.

According to exemplary embodiments, the thermochromic pigment in the thermochromic pigment-containing adhesive layer may form a concentration gradient that increases from the second region toward the first region in a planar direction.

According to exemplary embodiments, the thermochromic pigment-containing adhesive layer may include an adhesive resin and the thermochromic pigment dispersed in the adhesive resin.

According to exemplary embodiments, the packaging material may further include an intermediate substrate layer disposed between the metal layer and the thermochromic pigment-containing adhesive layer.

According to exemplary embodiments, the thermochromic pigment-containing adhesive layer may include an adhesive layer formed on the intermediate substrate layer and a thermochromic pigment application layer formed on the adhesive layer.

According to exemplary embodiments, a distance between a lower surface of the outer substrate layer and the upper surface of the metal layer may be greater than a distance between the lower surface of the metal layer and an upper surface of the inner sealant layer.

According to exemplary embodiments, the thermochromic pigment-containing adhesive layer may exhibit an irreversible color change in a range of 60° C. to 100° C.

A secondary battery according to exemplary embodiments includes: an electrode assembly including cathodes and anodes, which are repeatedly laminated; a pouch configured to accommodate the electrode assembly and including an inner sealant layer, a metal layer, a thermochromic pigment-containing adhesive layer, and an outer substrate layer, which are sequentially laminated from an upper surface of the electrode assembly; and a cathode lead and an anode lead which protrude outward from the pouch and are respectively connected to the cathode and the anode.

According to exemplary embodiments, the cathode may include a cathode current collector including a cathode tab which protrudes in a longitudinal direction of the secondary battery and is bonded to the cathode lead, and the anode may include an anode current collector including an anode tab which protrudes in the longitudinal direction of the secondary battery and is bonded to the anode lead.

According to exemplary embodiments, the pouch may include a first region including an overlapping region with the cathode tab in a planar direction and a second region spaced apart from the cathode lead with the first region interposed therebetween, wherein a content of the thermochromic pigment per unit area in the first region may be greater than that in the second region.

According to exemplary embodiments, the thermochromic pigment in the thermochromic pigment-containing adhesive layer may form a concentration gradient that decreases from the first region toward the second region in a planar direction.

According to exemplary embodiments, the anode tab and the cathode tab may be respectively disposed on opposite sides in the longitudinal direction of the electrode assembly, and the second region may include an overlapping region with the anode tab.

### Advantageous Effects

The packaging material for a battery according to the exemplary embodiments of the present disclosure includes a thermochromic pigment-containing adhesive layer that exhibits a color change depending on temperature, and a transparent outer substrate layer, thereby allowing temperature changes to be easily monitored visually from outside of the battery.

The packaging material for a battery may enable visual confirmation of the overall heating state of the battery from the outside through irreversible discoloration caused by a temperature increase.

The packaging material for a battery may enable the implementation of a secondary battery with high energy density per unit volume.

When the packaging material for a battery is applied to the secondary battery, the heating profile of the secondary battery may be visually observed on a unit area basis. Accordingly, it becomes possible to analyze the heating behavior of the secondary battery in two dimensions, rather than using a separate sensor that may merely detect the occurrence of heating.

The secondary battery according to exemplary embodiments of the present disclosure includes a pouch including the thermochromic pigment-containing adhesive layer and the transparent outer resin layer which covers the adhesive layer, such that heat generation due to an internal issue may be monitored from outside of the battery, and accidents such as fire or explosion caused by the heat generation may be prevented in advance.

The secondary battery may enable monitoring of abnormal temperature behavior near the cathode lead, where a large amount of heat is generated, especially during rapid charging.

The secondary battery may detect heat generation within the cell without the need to disassemble the cell.

### BRIEF DESCRIPTION OF DRAWINGS

FIGS. 1 to 4 are schematic cross-sectional views of packaging materials for a battery according to some exemplary embodiments.

FIG. 5 is a schematic view illustrating a portion of the manufacturing process of a packaging material for a battery according to some exemplary embodiments.

FIG. 6 is a schematic plan view illustrating a secondary battery according to some exemplary embodiments.

FIG. 7 is a schematic cross-sectional view of the secondary battery according to some exemplary embodiments.

FIGS. 8 and 9 are schematic plan views illustrating a secondary battery according to some exemplary embodiments.

FIG. 10 is a schematic view illustrating a discolored state of a pouch-type secondary battery according to some exemplary embodiments.

FIG. 11 is a view illustrating points where the temperature at different regions of the secondary battery of the experimental example was measured.

FIG. 12 is a graph illustrating the temperature change over time at each point shown in FIG. 11 during charging of the secondary battery in the experimental example.

### MODE FOR CARRYING OUT INVENTION

Embodiments of the present disclosure provide a packaging material for a battery which includes an adhesive layer containing a thermochromic pigment. In addition, a secondary battery including the packaging material for a battery is also provided.

Hereinafter, the embodiments of the present invention will be described in detail with reference to the accompanying drawings. However, since the drawings attached to the present disclosure are only given for illustrating one of several preferred embodiments of the present invention to easily understand the technical spirit of the present invention with the above-described invention, it should not be construed as limited to such a description illustrated in the drawings.

As used herein, the terms “upper surface,” “bottom,” “upper portion,” “bottom portion,” “lower surface,” “lower portion,” “front,” “rear,” etc. are used in a relative sense to distinguish the locations of components, and do not specify absolute locations thereof.

According to exemplary embodiments, there is provided a packaging material for a battery which includes: a metal layer; an inner sealant layer formed on a lower surface of the metal layer; an outer substrate layer laminated on an upper surface of the metal layer; and a thermochromic pigment-containing adhesive layer formed between the metal layer and the outer substrate layer.

The packaging material for a battery according to exemplary embodiments of the present disclosure includes the adhesive layer containing a thermochromic pigment that exhibits a color change depending on temperature, thereby allowing temperature changes to be easily monitored visually from outside of the battery.

The packaging material for a battery may enable visual confirmation of the overall heating state of the battery from the outside through irreversible discoloration caused by a temperature increase. The packaging material for a battery may enable the implementation of a secondary battery with high energy density per unit volume.

When the packaging material for a battery is applied to the secondary battery, the heating profile of the secondary battery may be visually observed on a unit area basis. Accordingly, it becomes possible to analyze the heating behavior of the secondary battery in two dimensions, rather than using a separate sensor that may merely detect the occurrence of heating.

According to exemplary embodiments, each of the metal layer, the inner sealant layer formed on the lower surface of the metal layer, and the outer substrate layer laminated on the upper surface of the metal layer may be laminated via adhesive layers. The outer substrate layer may be laminated on the upper surface of the metal layer via the thermochromic pigment-containing adhesive layer.

According to exemplary embodiments, the packaging material for a battery may further include an intermediate substrate layer disposed between the metal layer and the outer substrate layer. For example, the outer substrate layer may be laminated on an upper surface of the intermediate substrate layer via the thermochromic pigment-containing adhesive layer.

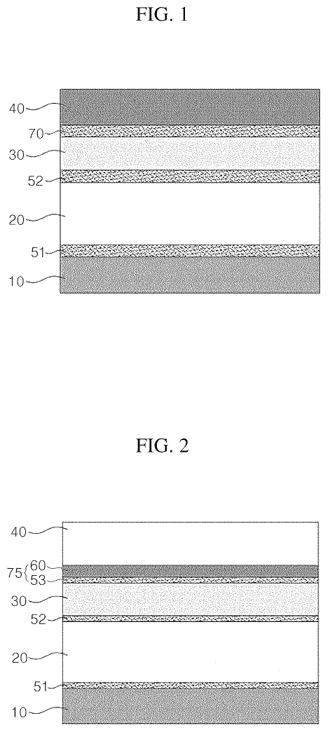

FIG. 1 is a schematic cross-sectional view of a packaging material for a battery according to some exemplary embodiments.

Referring to FIG. 1, the packaging material for a battery according to some exemplary embodiments may include an inner sealant layer 10, a metal layer 20, an intermediate substrate layer 30, and an outer substrate layer 40, wherein the respective layers may be laminated via adhesive layers 51, 52 and 70. The outer substrate layer 40 may be laminated on the upper surface of the intermediate substrate layer 30 via a thermochromic pigment-containing adhesive layer 70.

According to exemplary embodiments, the distance between the lower surface of the outer substrate layer 40 and the upper surface of the metal layer 20 may be greater than the distance between the lower surface of the metal layer 20 and the upper surface of the inner sealant layer 10.

According to exemplary embodiments, the thermochromic pigment-containing adhesive layer may include an adhesive layer formed on the intermediate substrate layer and a thermochromic pigment application layer formed on the adhesive layer.

FIG. 2 is a schematic cross-sectional view of a packaging material for a battery according to some exemplary embodiments.

Referring to FIG. 2, a thermochromic pigment-containing adhesive layer 75 according to some exemplary embodiments may include an adhesive layer 53 formed on the intermediate substrate layer 30 and a thermochromic pigment application layer 60 formed on the adhesive layer 53.

Hereinafter, each layer will be described in detail.

According to exemplary embodiments, the inner sealant layer 10 (see FIG. 1) is an inner resin layer in contact with an electrode assembly and an electrolyte, and may have excellent moisture resistance, heat resistance, insulating properties, and electrolyte resistance.

In addition, the inner sealant layer may be disposed at the bottom during the manufacture of the packaging material for a battery, and another film may be laminated thereon, thereby providing excellent lamination processability.

According to some exemplary embodiments, as the material of the inner sealant layer, polyolefin or a copolymer thereof may be used. For example, the inner sealant layer may include polyethylene (PE) and/or polypropylene (PP). When the inner sealant layer includes polyolefin or a copolymer thereof, it may provide excellent physical properties such as good heat-sealing properties, moisture resistance, and heat resistance, as well as excellent lamination processability, etc.

According to some exemplary embodiments, the thickness of the inner sealant layer may vary depending on the battery to be applied, for example, may be 10 μm to 100 μm, or 10 μm to 50 μm.

According to some exemplary embodiments, the metal layer 20 (see FIG. 1) may block the transmission of gas and light from the outside, and may increase the mechanical strength of the packaging material for a battery.

According to some exemplary embodiments, the metal layer may include aluminum, for example, a soft aluminum foil. In addition, the metal layer may include another metal component in addition to aluminum to improve the physical properties. For example, the metal layer may include an aluminum foil including iron (Fe).

In the aluminum foil containing the iron, the iron may be included in an amount of 0.1 to parts by weight (“wt parts”), or 1 to 8 wt parts, based on 100 wt parts of the total aluminum foil. When the aluminum foil containing iron is used in an amount within the above range, the processability of the metal layer may be excellent.

In the case of general metals, due to their low surface roughness, the surface of the metal layer may be provided with micro-roughness in order to increase adhesion with other layers. Specifically, micro-roughness may be formed on the surface of the metal layer through a process such as etching or degreasing.

According to some exemplary embodiments, the metal layer may have a thickness of, for example, 10 μm to 100 μm or 20 μm to 60 μm.

According to some exemplary embodiments, the intermediate substrate layer 30 (see FIG. 1) may function to protect the metal layer, and may exhibit excellent pinhole resistance, mechanical strength, and gas barrier properties.

According to some exemplary embodiments, the intermediate substrate layer may include a nylon film. The nylon film not only has excellent rupture strength, pinhole resistance, gas barrier properties, etc., but also exhibits superior heat resistance, cold resistance, and mechanical strength, making it suitable for use as the intermediate substrate layer. Examples of the nylon film include polyamide resins, i.e., nylon 6, nylon 66, a copolymer of nylon 6 and nylon 66, nylon 610, and poly(m-xylylene adipamide) (MXD6).

According to some exemplary embodiments, the intermediate substrate layer may have a thickness of, for example, 10 μm to 30 μm.

According to some exemplary embodiments, the outer substrate layer 40 (see FIG. 1) may be provided on the outermost surface of the packaging material for a battery. The outer substrate layer may function to protect the thermochromic pigment-containing adhesive layer, the intermediate substrate layer, the metal layer, and the inner sealant layer, which are provided on the lower surface thereof.

The outer substrate layer may be a transparent resin layer including an optically transparent light-transmitting resin. When the thermochromic pigment-containing adhesive layer 70, which is formed on the lower surface of the outer substrate layer, exhibits a color change depending on the temperature, heat generation within the battery may be transmitted to an external user as visual information, i.e., may be visually observed from the outside.

In addition, since the outer substrate layer may be exposed to the outside or may be in direct contact with another device, it may exhibit excellent insulating properties.

The light-transmitting resin may include at least one of polyethylene terephthalate (PET), polyethylene naphthalate (PEN), polybutylene terephthalate (PBT), liquid crystal polymer resin (LCP), copolyester, polycarbonate (PC) and nylon.

According to some exemplary embodiments, the outer substrate layer may have a thickness of 10 μm to 50 μm, or 10 μm to 30 μm. When the thickness is within the above range, the outer substrate layer may effectively exhibit a color change of the thermochromic pigment-containing adhesive layer, while resisting damage from external impact.

According to some exemplary embodiments, the thermochromic pigment-containing adhesive layers 70 and 75 (see FIGS. 1 and 2) include a thermochromic pigment that exhibits a color change depending on temperature. Therefore, when applied to a battery, heat generation within the battery may be visually observed from the outside.

For example, when heat is generated at a cathode tab portion of the battery, the color of the thermochromic pigment-containing adhesive layer of the battery pouch may change. Alternatively, by confirming the discoloration of the thermochromic pigment-containing adhesive layer caused by the heat generated during the operation of the battery, accidents such as battery damage or explosion may be prevented.

An opaque member may not be laminated on the upper portion of the thermochromic pigment-containing adhesive layer. Since the color change of the thermochromic pigment-containing adhesive layer depending on temperature should be visually observable from the outside, an opaque member that would obstruct such information transmission may be omitted. The thermochromic pigment-containing adhesive layer may be laminated on the upper surface of a metal layer having a metallic color, thereby enabling discoloration caused by battery heat generation to be externally visible regardless of the color of the metal layer.

According to exemplary embodiments, the thermochromic pigment may be uniformly dispersed within the thermochromic pigment-containing adhesive layer. That is, the content of the thermochromic pigment per unit area of the thermochromic pigment-containing adhesive layer may be substantially the same across different regions.

According to exemplary embodiments, the thermochromic pigment-containing adhesive layer may include a first region and a second region having different contents of the thermochromic pigments per unit area. Here, the content of the thermochromic pigment per unit area in the first region may be greater than that in the second region. The content of the thermochromic pigment in the second region may be zero. That is, the thermochromic pigment-containing adhesive layer may include a first region which contains thermochromic pigment and a second region which does not contain thermochromic pigment.

In order to target a region where temperature changes are to be more intensively monitored, the thermochromic pigment-containing adhesive layer may include a higher content of the thermochromic pigment in the first region than in the second region.

When the thermochromic pigment-containing adhesive layer includes a higher content of the thermochromic pigment in the first region, it may be easier to determine whether a part intended for monitoring the heat generation behavior of the battery is actually heated.

According to exemplary embodiments, the thermochromic pigment in the thermochromic pigment-containing adhesive layer may form a concentration gradient that increases from the second region toward the first region in a planar direction. The thermochromic pigment-containing adhesive layer may include the thermochromic pigment such that the concentration increases toward a target portion where temperature changes are to be more intensively monitored.

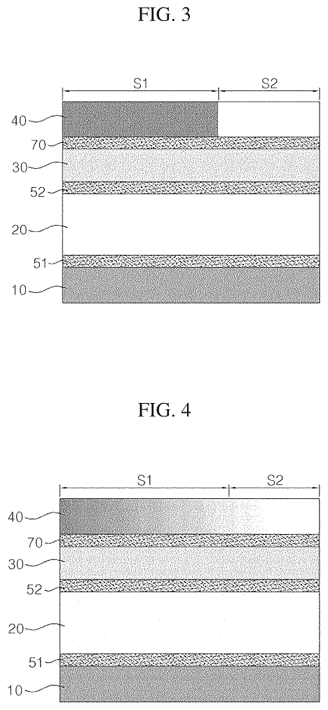

FIGS. 3 and 4 are schematic cross-sectional views of a packaging material for a battery according to some exemplary embodiments, respectively. In FIGS. 3 and 4, the content of the thermochromic pigment is represented by brightness, which is similarly applied in FIGS. 6, 8 and 9.

Referring to FIG. 3, in the packaging material for a battery according to exemplary embodiments, the thermochromic pigment-containing adhesive layer 70 may include a first region S1 and a second region S2, and the content of the thermochromic pigment per unit area in the first region S1 may be greater than that in the second region S2.

Referring to FIG. 4, in the packaging material for a battery according to exemplary embodiments, the thermochromic pigment-containing adhesive layer 70 may form a concentration gradient that increases from the second region S2 toward the first region S1 in the planar (arrow) direction. The concentration gradient may represent that the content of the thermochromic pigment increases from a point where the thermochromic pigment is not contained or a point where the content of the thermochromic pigment is the lowest to a point where the content of the thermochromic pigment is the highest.

According to exemplary embodiments, when the thermochromic pigment-containing adhesive layer 75 (see FIG. 2) includes the thermochromic pigment application layer 60 (see FIG. 2) and the adhesive layer 53 (see FIG. 2), the first region and the second region may be present in the thermochromic pigment application layer 60. That is, the thermochromic pigment application layer includes the first region and the second region having different contents of the thermochromic pigment per unit area, and the content of the thermochromic pigment per unit area in the first region may be greater than that in the second region.

In addition, within the thermochromic pigment application layer, the thermochromic pigment may form a concentration gradient that increases from the second region toward the first region in the planar direction.

According to exemplary embodiments, the thermochromic pigment-containing adhesive layer may include an adhesive resin and the thermochromic pigment dispersed within the adhesive resin.

The adhesive resin may serve to adhere the outer resin layer, the metal layer, the intermediate substrate layer and the inner sealant layer, and a material that does not cause side reactions with the thermochromic pigment may be used.

For example, the adhesive resin may include: an olefin resin such as polyethylene (PE) and polypropylene (PP), etc., or an olefin resin including a modified olefin resin thereof; an epoxy resin; a urethane resin; an acrylic resin and a nylon resin, etc. These may be used alone or in combination with two or more thereof.

According to some exemplary embodiments, the thermochromic pigment application layer 60 (see FIG. 2) may be formed by applying a composition including a thermochromic pigment.

For example, the composition including the thermochromic pigment may further include at least one selected from the group consisting of a polyurethane epoxy adhesive, a urethane resin and an acrylic resin in addition to the thermochromic pigment.

The thermochromic pigment may include a compound that exhibits a color change in response to a change in temperature. For example, the thermochromic pigment may include a compound that changes from the color at room temperature to a different color in a relatively low or high temperature environment. The thermochromic pigment may change, for example, from colorless to a specific color, from a specific color to another specific color, or from a specific color to colorless.

According to some exemplary embodiments, the thermochromic pigment may exhibit an irreversible color change. Specifically, the thermochromic pigment may be a hysteresis-type thermochromic pigment exhibiting irreversible color change behavior. More specifically, the thermochromic pigment may have different temperatures for color change and restoration, such that the color-changing property of the thermochromic pigment may become irreversible.

For example, if the thermochromic pigment that exhibits a color change at about 60° C. is a hysteresis thermochromic pigment, the temperature at which the color change is restored may be about −10° C. to 0° C. As the discoloration is maintained even when the temperature is decreased to room temperature after the discoloration, the hysteresis thermochromic pigment may exhibit irreversible behavior.

According to some exemplary embodiments, the thermochromic pigment-containing adhesive layer may exhibit changes in the wavelengths of absorbed and reflected light due to a change in the crystal structure of the thermochromic pigment, partial decomposition of internal bonds, or a change in the number of electrons resulting from bonding between electron acceptors and donors at high temperatures. As a result, discoloration of the thermochromic pigment-containing adhesive layer may occur.

According to some exemplary embodiments, the thermochromic pigment may have one or more discoloration points. The discoloration point may refer to a temperature reference point at which the color of the thermochromic pigment changes. For example, the thermochromic pigment may undergo a color change at a specific temperature or higher, or the thermochromic pigment may undergo a color change again at another specific temperature or higher after the discoloration at the specific temperature or higher.

According to some exemplary embodiments, the thermochromic pigment may exhibit a change in color density as the temperature increases. For example, the thermochromic pigment may become darker or lighter before the discoloration as the temperature increases. Therefore, when the thermochromic pigment-containing adhesive layer includes a thermochromic pigment whose color density varies with increasing temperature, continuous changes in temperature in the secondary battery may be confirmed. Specifically, when the thermochromic pigment-containing adhesive layer includes a thermochromic pigment that exhibits a change in color density as the temperature increases, the amount of heat generated in the secondary battery over time may be confirmed by observing the appearance of the secondary battery.

According to some exemplary embodiments, the thermochromic pigment may include one type of thermochromic pigment or two or more types of thermochromic pigments. When the thermochromic pigment includes two or more types of thermochromic pigments, the thermochromic pigments may not chemically react with each other.

In addition, when the thermochromic pigment includes two or more types of thermochromic pigments, each thermochromic pigment may influence the discoloration behavior of another thermochromic pigment due to the energy released or absorbed during their respective discoloration process. Accordingly, when the respective thermochromic pigments are used individually, they may have different discoloration points.

According to some exemplary embodiments, when the thermochromic pigment includes one type of thermochromic pigment, the thermochromic pigment-containing adhesive layer may exhibit the color of the thermochromic pigment before the discoloration. For example, when the thermochromic pigment is colorless before the discoloration, the metallic color of the metal layer that can be provided beneath the thermochromic pigment-containing adhesive layer may be visually observed before the discoloration.

According to some exemplary embodiments, when the thermochromic pigment includes one type of thermochromic pigment and the packaging material for a battery is exposed to a high temperature, the thermochromic pigment-containing adhesive layer may exhibit the color of the thermochromic pigment after the discoloration. For example, when the thermochromic pigment changes from a specific color to colorless, the metallic color of the metal layer that can be provided beneath the thermochromic pigment-containing adhesive layer may be visually observed after the discoloration.

According to some exemplary embodiments, when the thermochromic pigment includes two or more types of thermochromic pigments, the thermochromic pigments may have different discoloration temperatures. For example, the two or more types of thermochromic pigments may have discoloration points that are spaced apart from each other at predetermined temperature intervals.

For example, when the thermochromic pigment includes a first thermochromic pigment that exhibits a color change at about 60° C. and a second thermochromic pigment that exhibits a color change at about 90° C., three distinct colors can be observed.

Specifically, at a temperature below 60° C., a mixed color of the colors before the discoloration of two thermochromic pigments may be visually observed. At a temperature between about 60° C. and 90° C., a mixed color of the color after the discoloration of the first thermochromic pigment and the color before the discoloration of the second thermochromic pigment may be visually observed. At a temperature above 90° C., a mixed color of the colors after the discoloration of the two thermochromic pigments may be visually observed.

According to some exemplary embodiments, the color of the thermochromic pigment before and after the discoloration may be different from the metallic color. When the thermochromic pigment changes from a metallic color to another color or colorless, or from another color or colorless to a metallic color, it may be difficult to confirm the temperature change at high temperatures because it is not distinguished from the color of the metal layer disposed on the lower surface of the thermochromic pigment-containing adhesive layer.

According to exemplary embodiments, the thermochromic pigment-containing adhesive layer may exhibit an irreversible color change in a range of 60° C. to 100° C. That is, the thermochromic pigment may undergo a color change at 60° C. to 100° C.

For example, the thermochromic pigment may include one type of thermochromic pigment that exhibits a color change at 60° C. to 100° C. Alternatively, the thermochromic pigment may include two or more types of thermochromic pigments that change color at different temperatures within the range of 60° C. to 100° C.

According to some exemplary embodiments, the thermochromic pigment may include an organic thermochromic pigment and/or an inorganic thermochromic pigment, and may include, for example, an inorganic metal oxide such as (NiCO₃)ₓ(CdS)₁₋ₓ, COSiF₆, CdCO₃, CoCl₂·2(CH₂)₆N₄ and NiBr₂·(CH₂)₆N₄ or a hydrate of the metal oxide, or a mixture of the inorganic metal oxide or the hydrate of the metal oxide.

According to some exemplary embodiments, the thermochromic pigment-containing adhesive layer may include the thermochromic pigment in an amount of 3 to 10% by weight (“wt %”) based on a total weight of the thermochromic pigment-containing adhesive layer.

For example, when the thermochromic pigment-containing adhesive layer includes the thermochromic pigment only in the first region, the thermochromic pigment may be included in an amount of 3 to 10 wt % based on the total weight of the first region. In addition, for example, when the thermochromic pigment-containing adhesive layer has a concentration gradient of the thermochromic pigment, the lowest concentration and the highest concentration of the thermochromic pigment may be within a range of 3 to 10 wt %.

When the thermochromic pigment-containing adhesive layer includes the thermochromic pigment application layer, the above range also applies to the thermochromic pigment application layer. Specifically, the thermochromic pigment application layer may include the thermochromic pigment in an amount of 3 to 10 wt % based on the total weight of the thermochromic pigment application layer.

According to some exemplary embodiments, the thermochromic pigment-containing adhesive layer may further include at least one of a general pigment, a decolorizing agent and an antifoaming agent.

According to some exemplary embodiments, the thermochromic pigment-containing adhesive layer may further include a general pigment in addition to the thermochromic pigment. Even when the thermochromic pigment-containing adhesive layer uses a thermochromic pigment that is colorless before and after the discoloration together with the general pigment, the thermochromic pigment-containing adhesive layer may exhibit the color of the general pigment.

In addition, the thermochromic pigment-containing adhesive layer may include a decolorizing agent. The decolorizing agent may be added to enhance the color development of the pigment.

The thermochromic pigment-containing adhesive layer may include an antifoaming agent. The antifoaming agent may prevent bubble formation in the composition state of the thermochromic pigment-containing adhesive layer, thereby improving the processability of the composition.

The thermochromic pigment-containing adhesive layer may have a thickness of 0.1 μm to 15 μm, or 0.5 μm to 5 μm. In addition, the thermochromic pigment application layer may have a thickness of 0.1 μm to 5 μm. Within the above thickness range, the thermochromic pigment-containing adhesive layer may sufficiently exhibit a color change that can be observed visually from the outside.

According to some exemplary embodiments, the adhesive layers 51, 52 and 53 (see FIGS. 1 and 2) may be interposed between the respective layers to form a laminated structure. The adhesive layer may be an adhesive film, or may be formed by applying an adhesive composition to one surface of each layer, followed by curing or drying the same.

The adhesive composition may include an adhesive resin, and the same adhesive resin as described above may be used in this embodiment.

According to some exemplary embodiments, the adhesive layer may have a thickness of 0.1 μm to 10 μm, or 0.5 μm to 5 μm.

According to exemplary embodiments, a method of manufacturing the packaging material for a battery is provided.

According to some exemplary embodiments, the method of manufacturing the packaging material for a battery may provide a packaging material for a battery that allows visual confirmation of temperature changes from outside of the battery.

The method of manufacturing the packaging material for a battery may include the steps of: preparing an outer substrate layer; uniformly applying an adhesive composition including a thermochromic pigment to one surface of the outer substrate layer to form a thermochromic pigment-containing adhesive layer; preparing an inner sealant layer and a metal layer; forming an adhesive layer on the inner sealant layer and laminating the metal layer thereon; and laminating the outer substrate layer on the metal layer such that the thermochromic pigment-containing adhesive layer is interposed between the metal layer and the outer substrate layer.

According to some exemplary embodiments, the details of the packaging material for a battery, the thermochromic pigment, the outer substrate layer, the metal layer, the inner sealant layer and the adhesive layer may be the same as described above unless otherwise specified.

The outer substrate layer may be directly fabricated or prepared by purchasing an appropriate one from commercially available products.

The adhesive composition including the thermochromic pigment may include an adhesive resin and a thermochromic pigment. The thermochromic pigment may be included in the composition in a form dispersed in the melt of the adhesive resin.

According to some exemplary embodiments, the adhesive composition including the thermochromic pigment may include the thermochromic pigment in an amount of 3 to 10 wt % based on the total weight of the composition. For example, the composition may include a thermochromic pigment and an epoxy resin. Specifically, the composition may include the thermochromic pigment in an amount of 3 to 10 wt % and the epoxy resin in an amount of 90 to 97 wt %.

Alternatively, the adhesive composition including the thermochromic pigment may further include an organic solvent. The organic solvent may include, for example, toluene, tetrahydrofuran (THF), etc.

The thermochromic pigment-containing adhesive layer may be formed by applying the adhesive composition including the thermochromic pigment to one surface of the outer substrate layer. The application method is not particularly limited, and the application may be performed using a general method such as a bar coater or a die coater.

The thermochromic pigment-containing adhesive layer may be formed by applying the adhesive composition including the thermochromic pigment, followed by drying and/or curing the same.

The drying may be a process of evaporating a solvent or volatile component included in the composition to form an adhesive layer composed of a solid content.

Alternatively, the curing may be thermal curing or photo-curing, and may also form an adhesive layer by promoting cross-linking between resins in the adhesive composition through heating or light irradiation.

According to exemplary embodiments, an inner sealant layer and a metal layer may be prepared. The inner sealant layer and the metal layer may be prepared and used by purchasing commercially available products. Alternatively, these layers may be fabricated and used by a method known in the art.

The step of forming the adhesive layer may be conducted by applying an adhesive composition, followed by curing and/or drying the same. The adhesive composition may include an adhesive resin.

Alternatively, the step of forming the adhesive layer may be conducted by laminating an adhesive film. The adhesive film may be fabricated by applying an adhesive composition to a release film, followed by curing and/or drying the same, and then removing the release film.

According to exemplary embodiments, the prepared inner sealant layer, metal layer and outer substrate layer may be assembled to manufacture a packaging material for a battery. Specifically, an adhesive layer may be formed on the inner sealant layer and the metal layer may be laminated thereon, and an adhesive layer may be formed on the metal layer and the outer substrate layer may be laminated thereon.

The method of manufacturing the packaging material for a battery may also include the steps of: forming an adhesive layer on the metal layer and laminating an intermediate substrate layer thereon; and laminating the outer substrate layer on the intermediate substrate layer such that the thermochromic pigment-containing adhesive layer on the intermediate substrate layer is interposed between the intermediate substrate layer and the outer substrate layer. Details of the intermediate substrate layer may be the same as described above unless otherwise specified.

In addition, the method of manufacturing the packaging material for a battery may include the steps of: preparing an outer substrate layer, an adhesive film, an inner sealant layer and a metal layer; spraying a composition containing a thermochromic pigment between the outer substrate layer and the adhesive film and continuously laminating them to form a laminate having an outer substrate layer-thermochromic pigment application layer-adhesive layer structure; forming an adhesive layer on the inner sealant layer and laminating the metal layer thereon; and laminating the adhesive layer of the laminate on the metal layer so that they are in contact.

According to some exemplary embodiments, details of the packaging material for a battery, the thermochromic pigment, the outer substrate layer, the thermochromic pigment application layer, the metal layer, the inner sealant layer and the adhesive layer may be the same as described above unless otherwise specified.

According to exemplary embodiments, the outer substrate layer, the adhesive film, the inner sealant layer and the metal layer may be prepared in advance. The outer substrate layer, the adhesive film, the inner sealant layer and the metal layer may be prepared and used by purchasing commercially available products. Alternatively, these layers may be fabricated and used by a method known in the art.

According to exemplary embodiments, a composition containing the thermochromic pigment may be sprayed between the outer substrate layer and the adhesive film and continuously laminated to fabricate a laminate having an outer substrate layer-thermochromic pigment application layer-adhesive layer structure.

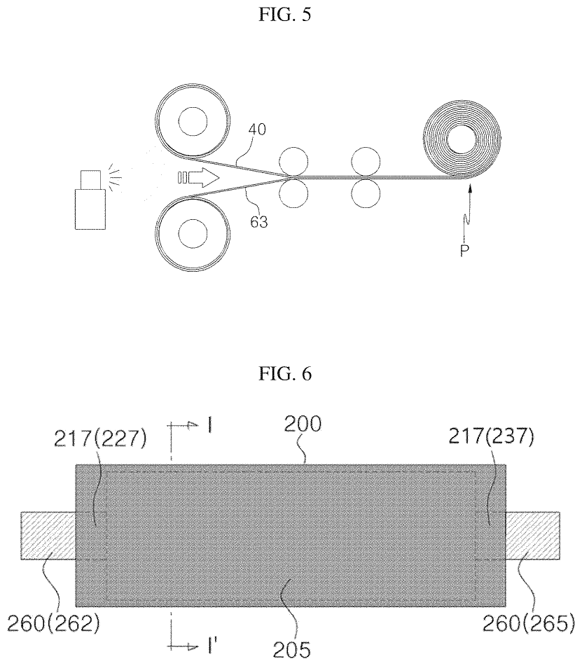

FIG. 5 is a schematic view illustrating a portion of the manufacturing process of a packaging material for a battery according to some exemplary embodiments.

Referring to FIG. 5, a composition containing a thermochromic pigment may be sprayed between the outer substrate layer 40 and an adhesive film 63 in the arrow direction and continuously laminated, thereby fabricating a transparent resin layer-thermochromic pigment application layer-adhesive film laminate P.

Specifically, in the process of continuously laminating an outer substrate layer 40 and the adhesive film 63, each rolled in a roll shape, a composition containing a thermochromic pigment is sprayed into the space between the outer substrate layer 40 and the adhesive film 63, thereby fabricating the laminate P in which a thermochromic pigment application layer is formed between the transparent resin film and the adhesive film.

In addition, according to some exemplary embodiments, a composition containing a thermochromic pigment may be sprayed only onto a portion of a region between the outer substrate layer 40 and the adhesive film 63, thereby forming a thermochromic pigment application layer containing a thermochromic pigment-containing region and a thermochromic pigment-free region.

According to some exemplary embodiments, the adhesive film 63 may have a release film provided on one surface. Specifically, the adhesive film 63 may have a release film provided on a surface opposite to the surface in contact with the thermochromic pigment application layer. The release film may serve to protect the adhesive surface of the adhesive film until the laminate P is later laminated with another layer, such as a metal layer or an intermediate substrate layer.

According to some exemplary embodiments, the composition containing a thermochromic pigment may be dried during the lamination process after spraying to form a thermochromic pigment application layer. During the drying process, volatile components such as solvents included in the composition containing the thermochromic pigment may be removed, and thus the thermochromic pigment application layer may be formed from the solid content of the composition.

According to some exemplary embodiments, the composition containing the thermochromic pigment may further include a solvent, such as water, ethanol, methanol and isopropyl alcohol, in addition to the thermochromic pigment.

According to some exemplary embodiments, the composition containing the thermochromic pigment may further include an additive for the purpose of improving durability and enabling the discoloration function of the thermochromic pigment. For example, the composition containing the thermochromic pigment may include a polyurethane-based adhesive, a modified epoxy, such as a siloxane-imide-based epoxy resin, etc. These may be used alone or in combination with two or more thereof.

According to some exemplary embodiments, the prepared inner sealant layer, metal layer, and laminate may be assembled to manufacture a packaging material for a battery. Specifically, the method may include the step of forming an adhesive layer on the inner sealant layer, laminating the metal layer thereon, and laminating the adhesive layer of the laminate on the metal layer so that they are in contact.

The method of manufacturing a packaging material for a battery may also include the steps of: forming an adhesive layer on the metal layer and laminating an intermediate substrate layer thereon; and laminating the adhesive layer of the laminate on the intermediate substrate layer so that they are in contact. Details of the intermediate substrate layer may be the same as described above unless otherwise specified.

According to exemplary embodiments, there is provided a secondary battery which includes an electrode assembly including cathodes and anodes, which are repeatedly laminated; a pouch configured to accommodate the electrode assembly and including an inner sealant layer, a metal layer, a thermochromic pigment-containing adhesive layer and an outer substrate layer, which are sequentially laminated from an upper surface of the electrode assembly; and a cathode lead and an anode lead which protrude outward from the pouch and are respectively connected to the cathode and the anode.

According to exemplary embodiments, the secondary battery includes a pouch including the thermochromic pigment-containing adhesive layer, such that heat generation due to an internal issue may be monitored from outside of the battery, and accidents such as fire or explosion caused by the heat generation may be prevented in advance.

The secondary battery may enable monitoring of abnormal temperature behavior near the cathode lead, where a large amount of heat is generated, especially during rapid charging. The secondary battery may detect heat generation within the cell without the need to disassemble the cell.

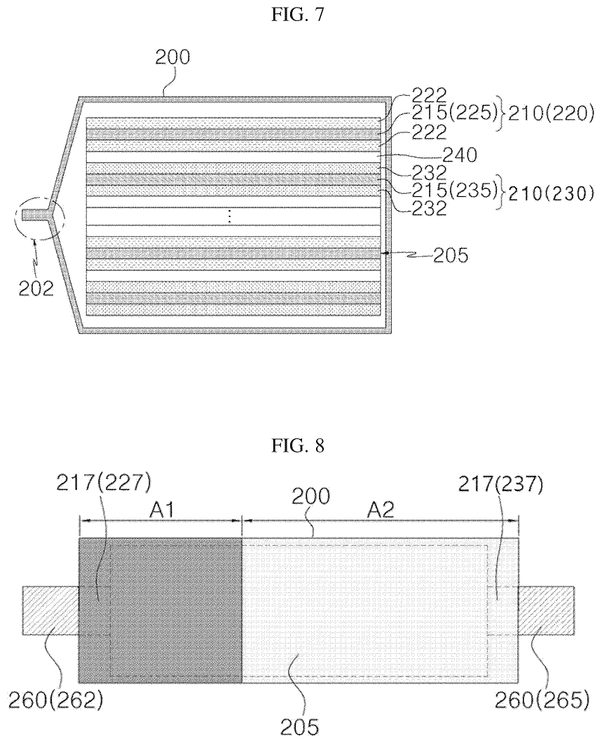

FIG. 6 is a schematic plan view illustrating a secondary battery according to some exemplary embodiments, and FIG. 7 is a schematic cross-sectional view of the secondary battery according to some exemplary embodiments. Specifically, FIG. 7 is a cross-sectional view taken on line I-I′ of FIG. 6 in a thickness direction of the battery.

Referring to FIG. 6 and FIG. 7, the secondary battery includes: an electrode assembly 205 including repeatedly laminated cathodes 220 and anodes 230; a pouch 200 configured to accommodate the electrode assembly 205 and including an inner sealant layer, a metal layer, a thermochromic pigment-containing adhesive layer, and an outer substrate layer, which are sequentially laminated from the upper surface of the electrode assembly; and a cathode lead 262 and an anode lead 265 which protrude outward from the pouch 200 and are respectively connected to the cathode and the anode.

The electrode assembly 205 may include repeatedly laminated electrodes 210 and a separation membrane 240 disposed between the electrodes 210. The electrodes 210 may each include active material layers 222 and 232 formed on electrode current collectors 215.

The electrodes 210 may include a cathode 220 and an anode 230. The electrode current collector 215 may include a cathode current collector 225 included in the cathode 220 and an anode current collector 235 included in the anode 230. The active material layer may include a cathode active material layer 222 included in the cathode 220 and an anode active material layer 232 included in the anode 230.

According to exemplary embodiments, the cathode 220 may include a cathode current collector 225 including a cathode tab 227 which protrudes in a longitudinal direction of the secondary battery and is bonded to the cathode lead 262, and the anode 230 may include an anode current collector 235 including an anode tab 237 which protrudes in the longitudinal direction of the secondary battery and is bonded to the anode lead 265.

The cathode current collector 225 of the cathode 220 and the anode current collector 235 of the anode 230 may each include a notching portion. The notching portion may be provided as, for example, an electrode tab portion 217. The notching portion may include a cathode notching portion protruding from the cathode current collector 225 and an anode notching portion protruding from the anode current collector 235.

The electrode current collector 215 may include the electrode tab portion 217. The tab portion 217 may include a cathode tab portion 227 protruding from the cathode current collector 225 and an anode tab portion 237 protruding from the anode current collector 235.

An electrode lead 260 may be electrically connected to the notching portion and exposed outward from the pouch 200. The electrode lead 260 may be provided as an external connection lead for supplying power to the secondary battery. Additionally, the electrode leads may be subdivided into the cathode lead 262 and the anode lead 265.

The cathode lead 262 may be connected to the cathode tab 227, and the anode lead 265 may be connected to the anode tab 237. In some embodiments, the cathode lead 262 and the anode lead 265 may be arranged on opposite sides of the secondary battery (see FIG. 6). In some embodiments, the cathode lead and the anode lead may be fused together on one side of the pouch.

The electrode assembly 205 and an electrolyte are accommodated in the pouch 200, then the pouch 200 may be folded so that the inner sealant layers of the pouch face each other. Thereafter, a sealing portion 202 may be performed through a sealing process

An electrode cell is defined by the cathode, the anode and the separation membrane, and a plurality of electrode cells may be stacked to define an electrode assembly. The electrode assembly may include a plurality of electrode cells each including the cathode, the anode and the separation membrane.

The cathode may include a cathode current collector and a cathode active material layer formed by applying a cathode active material to the cathode current collector. The cathode active material may include a compound capable of reversibly intercalating and deintercalating lithium ions. In this case, the secondary battery may be provided as a lithium secondary battery.

In exemplary embodiments, the cathode active material may include lithium-transition metal composite oxide particles. As examples of a lithium-transition metal composite oxide included in the lithium-transition metal composite oxide particles, lithium-manganese oxide, lithium-cobalt oxide, lithium-nickel oxide, lithium-manganese-cobalt oxide, etc. may be considered. In addition, in some exemplary embodiments, the lithium-transition metal composite oxide particles include nickel (Ni), and may further include at least one of cobalt (Co) or manganese (Mn).

For example, the lithium-transition metal composite oxide particles may be represented by Formula 1 below.

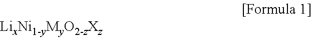

In Formula 1, x, y and z may be in a range of 0.9≤x≤1.1, 0≤y≤0.7, and −0.1≤z≤0.1, respectively. M may represent one or more elements selected from Na, Mg, Ca, Y, Ti, Zr, Hf, V, Nb, Ta, Cr, Mo, W, Mn, Co, Fe, Cu, Ag, Zn, B, Al, Ga, C, Si, Sn or Zr, and X may represent an element selected from O, F, S and P.

In one embodiment, a molar ratio (1-y) of nickel in Formula 1 may be in the range of 0.8 to 0.95. In this case, it is possible to increase output and capacity of the secondary battery through a cathode composition of high-nickel (high-Ni) contents. As the content of nickel included in the cathode active material increases, the generation of gas due to the side reaction between the cathode active material and the electrolyte may also increase.

In addition, the lithium-transition metal composite oxide particle may be represented by Formula 2 below, and the lithium-transition metal composite oxide particle represented by Formula 2 may have an olivine structure.

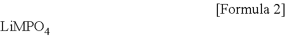

In Formula 2, M is at least one element of Fe, Mn, Ni, Co and V.

The cathode current collector may include a metal material that is unreactive in a charging/discharging voltage range of the secondary battery and facilitates application and adhesion of the electrode active material. For example, the cathode current collector may include stainless steel, nickel, aluminum, titanium, copper, zinc, or an alloy thereof, and preferably includes aluminum or an aluminum alloy.

For example, a slurry may be prepared by mixing the cathode active material with a binder, a conductive material and/or a dispersant in a solvent, followed by stirring the mixture. The slurry may be coated on the cathode current collector, followed by compression and drying to prepare the cathode including the cathode active material layer.

The binder may be selected from, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as a binder for forming the cathode. In this case, an amount of the binder for forming the cathode active material layer may be reduced and an amount of the cathode active material may be relatively increased, thus to improve the output and capacity of the secondary battery.

The conductive material may be included to facilitate electron transfer between the active material particles. For example, the conductive material may include a carbon-based conductive material such as graphite, carbon black, graphene, or carbon nanotubes and/or a metal-based conductive material such as tin, tin oxide, titanium oxide, or a perovskite material such as LaSrCoO₃, or LaSrMnO₃.

The anode may include the anode current collector, and the anode active material layer formed by applying an anode active material on the anode current collector.

As the anode active material, any active material known in the related art may be used, so long as it can intercalate and deintercalate lithium ions. For example, carbon-based materials such as crystalline carbon, amorphous carbon, carbon composite, carbon fiber, etc., a lithium alloy, or a silicon (Si)-based active material may be used.

Examples of the crystalline carbon may include graphite-based carbons such as natural graphite, artificial graphite, graphite cokes, graphite MCMB, and graphite MPCF, etc.

Examples of the amorphous carbon may include hard carbon, cokes, mesocarbon microbead (MCMB), mesophase pitch-based carbon fiber (MPCF), etc.

Elements included in the lithium alloy may include, for example, aluminum, zinc, bismuth, cadmium, antimony, silicon, lead, tin, gallium or indium, etc.

In one embodiment, the anode active material may include a silicon-based active material to implement a high-capacity lithium secondary battery. The silicon-based active material may include SiOx (0<x<2) or SiOx (0<x<2) containing a lithium (Li) compound. The SiOx containing the Li compound may be SiOx containing lithium silicate. The lithium silicate may be present in at least a portion of SiOx (0<x<2) particles, for example, may be present inside and/or on surfaces of the SiOx (0<x<2) particles. In one embodiment, the lithium silicate may include Li₂SiO₃, Li₂Si₂O₅, Li₄SiO₄, Li₄Si₃O₈ and the like.

The silicon-based active material may include, for example, a silicon-carbon composite compound such as silicon carbide (SiC).

The anode current collector may include stainless steel, copper, nickel, aluminum, titanium, or an alloy thereof. Preferably, the anode current collector includes copper or a copper alloy.

For example, the anode active material may be prepared in the form of a slurry by mixing the same with the above-described binder, conductive material, and thickener in a solvent, followed by stirring the mixture. The slurry may be coated on at least one surface of the anode current collector, followed by compression and drying to prepare the anode including the anode active material layer.

As the binder and the conductive material, materials which are substantially the same as or similar to the above-described materials used in the cathode active material layer may be used. In some embodiments, a binder for forming the anode may include, for example, an aqueous binder such as styrene-butadiene rubber (SBR) to ensure compatibility with a carbon-based active material, and may be used together with a thickener such as carboxymethyl cellulose (CMC).

The separation membrane may be interposed between the cathode and the anode. The separation membrane may include a porous polymer film made of a polyolefin polymer such as ethylene homopolymer, propylene homopolymer, ethylene/butene copolymer, ethylene/hexene copolymer, ethylene/methacrylate copolymer. The separation membrane may include a nonwoven fabric made of glass fibers having a high melting point, polyethylene terephthalate fibers, etc.

The electrode assembly 205 may be accommodated in the pouch 200 together with the electrolyte to define a secondary battery. For example, a battery cell may be defined by the pouch 200 and the electrode assembly 205 accommodated in the pouch 200 as shown in FIGS. 6 and 7.

A non-aqueous electrolyte may be used as the electrolyte. The non-aqueous electrolyte may include a lithium salt of an electrolyte and an organic solvent, the lithium salt is expressed by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, γ-butyrolactone, propylene sulfite, tetrahydrofuran, and the like may be used. These compounds may be used alone or in combination with two or more thereof.

The pouch 200 may be fabricated from the packaging material for a battery according to the above-described exemplary embodiments. The above-described features of the packaging material for a battery may be equally applied to the pouch 200.

FIG. 8 is a schematic plan view illustrating a secondary battery according to some exemplary embodiments.

Referring to FIG. 8, the pouch 200 includes a first region A1 including an overlapping region with the cathode tab 227 in a planar direction and a second region A2 spaced apart from the cathode lead with the first region interposed therebetween, and the content of the thermochromic pigment per unit area in the first region A1 may be greater than that in the second region A2.

The first region A1 may include an overlapping region with the cathode tab 227, which is a portion that generates a particularly large amount of heat during operation of the secondary battery. When heat is generated in the cathode tab 227 portion, heat generation information for preventing an accident may be identified through discoloration of the thermochromic pigment-containing adhesive layer of the pouch 200.

The content of the thermochromic pigment per unit area in the first region A1 may be greater than that in the second region A2. Heat generation in the cathode tab 227 portion may be more intensively monitored.

According to exemplary embodiments, the anode tab 237 and the cathode tab 227 are respectively disposed on opposite sides in the longitudinal direction of the electrode assembly 205, and the second region A2 may include an overlapping region with the anode tab 237.

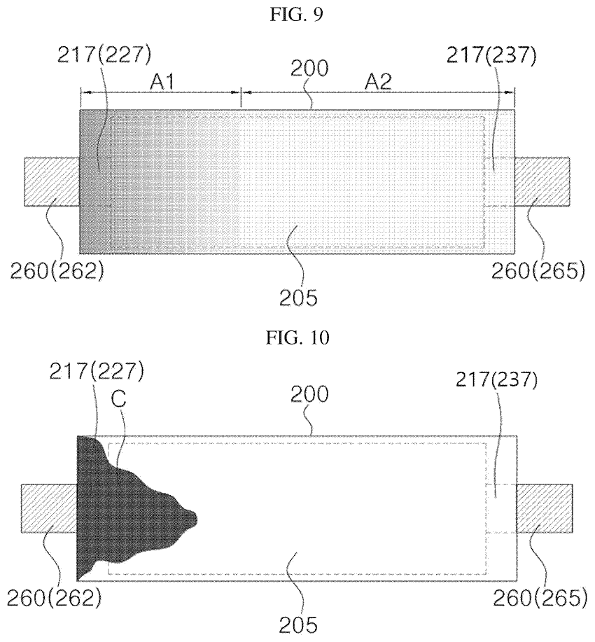

FIG. 9 is a schematic plan view of a secondary battery according to some exemplary embodiments.

Referring to FIG. 9, the thermochromic pigment in the thermochromic pigment-containing adhesive layer included in the pouch 200 may form a concentration gradient that decreases from the first region A1 toward the second region A2 in the planar direction.

That is, the thermochromic pigment in the thermochromic pigment-containing adhesive layer may form a concentration gradient that increases from the second region A2 toward the first region A1 in the planar direction. When the concentration of the thermochromic pigment increases in the first region A1 direction, the heat generation at the cathode tab 227 portion may be more intensively monitored.

The secondary battery according to some exemplary embodiments may generate internal heat due to battery operation such as charging and discharging. Alternatively, the secondary battery may generate internal heat due to damage or a short circuit of the electrode assembly caused by external impact.

The heat generation inside the battery may be identified through the discoloration of the thermochromic pigment-containing adhesive layer from the outside. The secondary battery may undergo a color change at a discoloration point of the thermochromic pigment included in the thermochromic pigment-containing adhesive layer, for example, in the range of 60° C. to 100° C.

FIG. 10 is a schematic view illustrating a discolored state of a secondary battery according to some exemplary embodiments.

Referring to FIG. 10, a region of a discolored portion C may be identified on the cathode lead 262 side of the secondary battery. It can be determined that heat was generated in the region of the electrode assembly 205 corresponding to the discolored portion C of the thermochromic pigment-containing adhesive layer. Through the discolored portion C, the heat-generating portion and area of the secondary battery may be easily observed visually, and the heat generation state of the battery may be identified without the need to disassemble the battery.

In order to experimentally confirm heat generation on the cathode lead side, a battery was manufactured and evaluated as follows.

### Experimental Example

### (1) Preparation of Cathode

LiNi_{0.8}Co_{0.1}Mn_{0.1}O₂(NCM 811), carbon nanotubes (CNTs), and polyvinylidene fluoride (PVDF) were mixed in a weight ratio of 98:1:1, and the mixture was dispersed in N-methyl-2-pyrrolidone (NMP) to prepare a cathode slurry.

The cathode slurry was applied to a region of an aluminum foil having a protrusion part (cathode tab) on one side except for the protrusion part, followed by drying and pressing the same, to prepare a cathode.

### (2) Preparation of Anode

Artificial graphite, silicon, carbon nanotubes (CNTs), styrene-butadiene rubber (SBR) and carboxymethyl cellulose (CMC) were mixed in a weight ratio of 94:1:3:1:1, and the mixture was dispersed in distilled water to prepare an anode slurry.

The anode slurry was applied to a region of a copper foil having a protrusion (anode tab) on one side except for the protrusion part, followed by drying and pressing the same, to prepare an anode.

### (3) Manufacture of Battery

A polyethylene separation membrane (thickness: 20 μm) was interposed between the cathode and the anode to form an electrode assembly. A cathode lead and an anode lead were welded to the cathode tab and the anode tab, respectively.

A 1 M lithium hexafluorophosphate (LiPF₆) solution (a mixed solvent of EC and EMC in a ratio of 30:70 v/v) was prepared. An electrolyte was prepared by adding 1 wt % of fluoroethylene carbonate (FEC), 1 wt % of lithium difluorophosphate (LiPO₂F₂), 0.5 wt % of 1,3-propane sultone (PS), 0.5 wt % of propene sultone (PRS) and the balance solvent, to form the 1 M lithium hexafluorophosphate solution, based on the total weight of the electrolyte.

The electrode assembly was housed in a pouch (thickness: 153 mm, 1.44 g/cc, DNP) so that some regions of the cathode lead and the anode lead were exposed to the outside, followed by sealing three sides except for the side of an electrolyte injection part.

A lithium secondary battery was manufactured by injecting the electrolyte into the pouch and sealing the side of the electrolyte injection part.

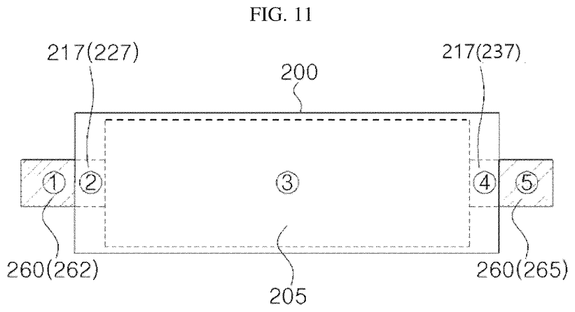

FIG. 11 is a view illustrating points where the temperature at different regions of the secondary battery of the experimental example was measured.

Temperature measurement sensors (GL800) were attached to each point of the secondary battery shown in FIG. 11. The temperature change was observed while charging the secondary battery used in the experimental example. During applying a 10-minute charging protocol with a current ranging from 6 C-rate to 1.5 C-rate, from state-of-charge (SOC) 10% to SOC 80%, the temperature change over time at each part (Point 1 to Point 5) of the secondary battery shown in FIG. 11 was measured using the temperature measurement sensors.

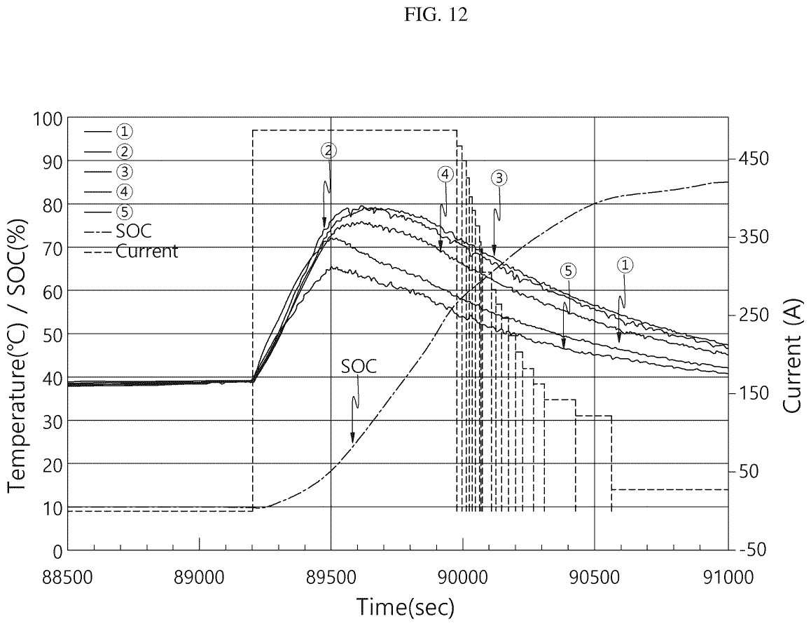

FIG. 12 is a graph illustrating the temperature change over charging time at each point shown in FIG. 11 for the secondary battery used in the experimental example. FIG. 12 shows the change in SOC (dashed line) and the charging protocol (dotted line) over the charging time together.

Referring to FIGS. 11 and 12, it can be seen that the highest heat generation occurs at Point 2, corresponding to the cathode tab 227, and at Point 3, the central portion between the cathode tab 227 and the anode tab 237.

The pouch-type secondary battery according to some exemplary embodiments may allow visual observation of heat generation at the cathode tab portion on the cathode lead side from outside of the battery, and accidents such as explosions may be prevented in advance by identifying the heating behavior.

What is claimed is:

1. A packaging material for a battery comprising:
a metal layer;
an inner sealant layer formed on a lower surface of the metal layer;
an outer substrate layer laminated on an upper surface of the metal layer; and
a thermochromic pigment-containing adhesive layer formed between the metal layer and the outer substrate layer.

2. The packaging material for a battery according to claim 1, wherein the thermochromic pigment-containing adhesive layer comprises a first region and a second region having different contents of the thermochromic pigments per unit area, and the content of the thermochromic pigment per unit area in the first region is greater than that in the second region.

3. The packaging material for a battery according to claim 2, wherein the thermochromic pigment in the thermochromic pigment-containing adhesive layer forms a concentration gradient that increases from the second region toward the first region in a planar direction.

4. The packaging material for a battery according to claim 1, wherein the thermochromic pigment-containing adhesive layer comprises an adhesive resin and the thermochromic pigment dispersed in the adhesive resin.

5. The packaging material for a battery according to claim 4, further comprising an intermediate substrate layer disposed between the metal layer and the thermochromic pigment-containing adhesive layer.

6. The packaging material for a battery according to claim 5, wherein the thermochromic pigment-containing adhesive layer comprises an adhesive layer formed on the intermediate substrate layer and a thermochromic pigment application layer formed on the adhesive layer.

7. The packaging material for a battery according to claim 5, wherein a distance between a lower surface of the outer substrate layer and the upper surface of the metal layer is greater than a distance between the lower surface of the metal layer and an upper surface of the inner sealant layer.

8. The packaging material for a battery according to claim 1, wherein the thermochromic pigment-containing adhesive layer exhibits an irreversible color change in a range of 60° C. to 100° C.

9. A secondary battery comprising:
an electrode assembly comprising cathodes and anodes, which are repeatedly laminated;
a pouch configured to accommodate the electrode assembly and comprising an inner sealant layer, a metal layer, a thermochromic pigment-containing adhesive layer, and an outer substrate layer, which are sequentially laminated from an upper surface of the electrode assembly; and
a cathode lead and an anode lead which protrude outward from the pouch and are respectively connected to the cathode and the anode.

10. The secondary battery according to claim 9, wherein the cathode comprises a cathode current collector comprising a cathode tab which protrudes in a longitudinal direction of the secondary battery and is bonded to the cathode lead, and
the anode comprises an anode current collector comprising an anode tab which protrudes in the longitudinal direction of the secondary battery and is bonded to the anode lead.

11. The secondary battery according to claim 10, wherein the pouch comprises a first region comprising an overlapping region with the cathode tab in a planar direction and a second region spaced apart from the cathode lead with the first region interposed therebetween,
wherein a content of the thermochromic pigment per unit area in the first region is greater than that in the second region.

12. The secondary battery according to claim 11, wherein the thermochromic pigment in the thermochromic pigment-containing adhesive layer forms a concentration gradient that decreases from the first region toward the second region in a planar direction.

13. The secondary battery according to claim 11, wherein the anode tab and the cathode tab are respectively disposed on opposite sides in the longitudinal direction of the electrode assembly, and
the second region comprises an overlapping region with the anode tab.
